(19) United States
(12) Patent Application Publication
(10) Pub. No.: US 2026/0213285 A1
(43) Pub. Date: Jul. 23, 2026

(54) AC BATTERY SYSTEM

(71) Applicant: Sparq Systems Inc., Kingston (CA)

(72) Inventors: Majid PAHLEVANINEZHAD, Kingston (CA); Abhishek AWASTHI, Kingston (CA); Justin WOELFLE, Kingston (CA); Praveen K. JAIN, Kingston (CA)

(21) Appl. No.: 19/032,210

(22) Filed: Jan. 20, 2025

(51) Int. Cl. H01M 10/42; H01M 10/6555; H02M 1/44; H02M 7/5387

(52) U.S. Cl. CPC H01M 10/4257; H01M 10/4264; H01M 10/6555; H02M 1/44; H02M 7/53871; H01M 2010/4278

(57) ABSTRACT

Systems and circuits relating to an AC battery system. An AC battery system that outputs AC power is provided. Provided are integrated energy blocks with each energy block having one or more energy storage cells and a Cell-PE block that contains power electronics components. Various configurations of the AC battery system may include an integrated full bridge or half-bridge DC/AC inverter. Various configurations of the cell-PE block may include low and high voltage half-bridge circuits, an isolation transformer, as well as a full bridge inverter.

### TECHNICAL FIELD

The present invention relates to energy storage. More specifically, the present invention relates to systems and methods relating to self-contained energy storage systems with integrated electronics and which provide AC power.

### BACKGROUND

Energy storage is an integral element of most electronics and will play a major role in future energy systems. In particular, energy storage is instrumental in the paradigm shift towards renewable energy systems such as solar power and wind power based energy systems. Energy storage can effectively compensate for the intermittent nature of renewable energy systems and can offer a practical solution for future power generation. Energy storage systems can also effectively resolve the issue of intermittency for solar energy harvesting systems by storing the energy and releasing this energy when needed.

Batteries are a type of energy storage with very high energy density and batteries are poised to dominate the residential and commercial energy market. FIG. 1 shows a typical battery-based energy storage system that integrates a battery management system. Supercapacitors are also becoming a contender to batteries. However, the energy density of supercapacitors is much lower than batteries. FIG. 2 shows a supercapacitor based energy storage system. It is well-known that batteries provide DC power and, accordingly, this power needs to be converted to AC to cater to current utility grids and AC loads. Because of this, an energy storage unit usually comes with a bidirectional inverter that converts DC power into AC power. Since each battery cell has relatively low voltage (~3-4V), battery cells are commonly stacked into a multi-cell battery pack in series. Multiple strings of these multi-cell battery packs are then connected in parallel. As can be seen from FIG. 1, the battery pack requires a battery management system (BMS) and a cell balancing circuit to ensure reliable operation of the battery pack.

According to FIG. 1, the battery pack includes a battery management system (BMS) that monitors various parameters such as cell voltage, cell health, temperature, etc. to ensure the reliable operation of the battery pack. In addition, since there are several cells placed in series in a string, there is a voltage balancer that performs voltage balancing of cells in a string and reliable operation of the battery pack. There is usually a communications link between the BMS and the electronics to transfer information (such as State-of-Charge (SoC), State-of-Health (SoH), etc.) to the inverter. The BMS, voltage balancer, and the battery inverter add extra costs to the energy storage system and this, unfortunately, makes the solution very costly and quite complicated.

There is therefore a need for systems and devices which mitigate if not avoid the shortcomings of the prior art.

### SUMMARY

The present invention provides systems and circuits relating to an AC battery system. An AC battery system that outputs AC power is provided. Provided are integrated energy blocks with each energy block having one or more energy storage cells and a Cell-PE block that contains power electronics components. Various configurations of the AC battery system may include an integrated full bridge or half-bridge DC/AC inverter. Various configurations of the cell-PE block may include low and high voltage half-bridge circuits, an isolation transformer, as well as a full bridge inverter.

In a first aspect, the present invention provides a power cell system for providing power to grids or loads requiring AC power, the system comprising:
at least one power block, each power block comprising:
   at least one energy storage cell for storing energy;
   a circuitry sub-block containing circuitry for power flow to and from said at least one energy cell and for energy conditioning for said at least one energy cell;
a control sub-system for controlling said at least one power block and for setting parameters for said circuitry sub-block in said at least one power block;
   wherein said power cell system outputs AC power.

In one aspect, the power cell system further comprises a communications block for receiving and transmitting data to and from said power cell system, the data being received and sent from said control sub-system. The power cell system may include at least one heat sink.

The power cell system may comprise:
a plurality of pairs of circuit element modules, each of said circuit element modules comprising a semiconductor;
a plurality of said flying capacitors, each flying capacitor being associated with a specific pair of circuit element modules;
a pair of output circuit element modules coupled to each other in series;
an EMI filter circuitry block;
   wherein
each of said plurality of circuit element modules is coupled in series to other circuit element modules to form a chain of circuit element modules;
each flying capacitor is coupled between a first coupling point and a second coupling point in said chain of circuit element modules and each flying capacitor and each pair of circuit element modules are arranged in said chain such that, for each specific flying capacitor, a specific pair of circuit element modules associated with said specific flying capacitor is coupled in said chain between a specific first coupling point and a specific second coupling point between which said specific flying capacitor is coupled;
said output circuit element modules in series is coupled in parallel with said chain;
said EMI filter circuitry block is coupled between an output of said power block and a coupling point that is midway in said chain;
said output is coupled to a point midway between said output circuit element modules;
each flying capacitor is coupled in parallel with a string of series coupled energy blocks;
switching pulses produced by said control sub-system controls said semiconductors in said circuit element modules.

The power cell system may comprise:
a plurality of pairs of circuit element modules, each of said circuit element modules comprising a semiconductor, said plurality of pairs of circuit element modules being arranged in two chains of circuit element modules;
a plurality of said flying capacitors, each flying capacitor being associated with a specific pair of circuit element modules;
a first output filter circuitry block and a second output filter circuitry block;
   wherein
each of said plurality of circuit element modules is coupled in series to other circuit element modules to thereby form said two chains of circuit element modules, a first chain of circuit element modules being in parallel with a second chain of circuit element modules;
each flying capacitor being coupled between a first coupling point and a second coupling point in said chain of circuit element modules and each flying capacitor and each pair of circuit element modules are arranged in one of said two chains such that, for each specific flying capacitor, a specific pair of circuit element modules associated with said specific flying capacitor is coupled in said one of two chains between a specific first coupling point and a specific second coupling point between which said specific flying capacitor is coupled;
said first output filter circuitry block is coupled between an output and a first coupling point midway in said first chain of circuit element modules;
said second output filter circuitry block is coupled between said output and a second coupling point midway in said second chain of circuit element modules;
each flying capacitor is coupled in parallel with a string of series coupled energy blocks;
switching pulses produced by said control sub-system controls said semiconductors in said circuit element modules.

For the at least one power block, the circuitry sub-block may comprise:
a pair of circuit element modules, each of said circuit element modules comprising a semiconductor, said pair of circuit element modules being coupled in series to result in a series-coupled pair of circuit element modules;
an output capacitor coupled in parallel with said series-coupled pair of circuit element modules;
an inductor coupled between a first input lead and a coupling point, said coupling point being between said pair of circuit element modules;
an input capacitor coupled between said first input lead and a second input lead;
a control and modulation sub-block for generating gating logic for semiconductors in said circuit element modules;
   wherein said second input lead is coupled to said series-coupled pair of circuit element modules and to said output capacitor;
   wherein, in each of said at least one power block, one or more energy storage cells are coupled between said first input lead and said second input lead.

Alternatively, for the least one power block, the circuitry sub-block may comprise:
a low-voltage half-bridge circuit;
a high voltage half-bridge circuit;
an isolation transformer coupled between said low-voltage half-bridge circuit and said high voltage half-bridge circuit;
a control and modulation sub-block for generating gating logic for semiconductors in said low-voltage half-bridge circuit and in said high-voltage half-bridge circuit.

The low-voltage half-bridge circuit may comprise:
a pair of low voltage circuit element modules, each of said low voltage circuit element modules comprising a semiconductor, said pair of low voltage circuit element modules being coupled in series to result in a series-coupled pair of low voltage circuit element modules;
a pair of output capacitors coupled in series with each other to result in a series-coupled pair of output capacitors, said series coupled pair of output capacitors being coupled in parallel with said series-coupled pair of low voltage circuit element modules;
an input inductor coupled between a first input lead and a first coupling point, said coupling point being between said pair of circuit element modules;
an input capacitor coupled between said first input lead and a second input lead;
an output inductor coupled between said first coupling point and a first input to said isolation transformer;
   wherein a second input to said isolation transformer is coupled to a second coupling point, said second coupling point being between said pair of output capacitors.

The high-voltage half-bridge circuit may comprise:
a pair of high voltage circuit element modules, each of said high voltage circuit element modules comprising a semiconductor, said pair of high voltage circuit element modules being coupled in series to result in a series-coupled pair of high voltage circuit element modules;
a pair of input capacitors coupled in series with each other to result in a series-coupled pair of input capacitors, said series-coupled pair of input capacitors being coupled in parallel with said series-coupled pair of high voltage circuit element modules;
an input high voltage inductor coupled between a first coupling point and a first output of said isolation transformer, said first coupling point being between said pair of high voltage circuit element modules;
   wherein a second output from said isolation transformer is coupled to a second coupling point, said second coupling point being between said pair of input capacitors;
   wherein said pair of high voltage circuit element modules and said pair of input capacitors are coupled between a first output lead and a second output lead.

Alternatively, for the at least one power block, the circuitry sub-block may comprise:
a low-voltage half-bridge circuit;
a high voltage half-bridge circuit;
an isolation transformer coupled between said low-voltage half-bridge circuit and said high voltage half-bridge circuit;
a full-bridge inverter circuit coupled to said high voltage half-bridge circuit;
a control and modulation sub-block for generating gating logic for:
   semiconductors in said low-voltage half-bridge circuit;
   semiconductors in said high-voltage half-bridge circuit; and
   semiconductors in said full-bridge inverter circuit.

The full-bridge inverter circuit may comprise:
a first pair and a second pair of inverter circuit element modules, each of said inverter circuit element modules comprising a semiconductor, said first pair of inverter circuit element modules being coupled in series to result in a first series-coupled pair of inverter circuit element modules and said second pair of inverter circuit element modules being coupled in series to result in a second series-coupled pair of inverter circuit element modules, said first series-coupled pair of inverter circuit element modules and second series-coupled pair of inverter circuit element modules being coupled in parallel to each other;
an AC grid filter coupled between a first output lead and a first coupling point between said first pair of inverter circuit element modules;
   wherein a second output lead is coupled to a second coupling point between said second pair of inverter circuit element modules.

In one aspect, the power cell system comprises at least two power blocks that are coupled in parallel.

In a further aspect, each energy storage cell in each energy block is one of: a battery, a supercapacitor, and a hybrid of a battery and a supercapacitor.

As another aspect, the circuitry sub-block may further comprise a communications sub-block.

### BRIEF DESCRIPTION OF THE DRAWINGS

The embodiments of the present invention will now be described by reference to the following figures, in which identical reference numerals in different figures indicate identical elements and in which:

FIG. 1 shows a battery-based energy storage system according to the prior art;

FIG. 2 illustrates a supercapacitor-based energy storage system according to the prior art;

FIG. 3 shows a block diagram of an AC battery system according to one aspect of the present invention;

FIG. 4 shows a battery pack according to yet a further aspect of the present invention;

FIG. 5 illustrates a schematic diagram of one aspect of the present invention and showing the configuration of the various components;

FIGS. 6-8 show schematic diagrams of an AC battery according to another aspect of the present invention that uses a totem-pole multi-level DC/AC inverter and which uses different types of energy storage cells in use;

FIGS. 9-11 illustrate schematic diagrams of an AC battery according to a further aspect of the present invention that uses a full-bridge multi-level DC/AC inverter and which uses different types of energy storage cells in use;

FIG. 12 shows a schematic diagram of one configuration for a non-isolated Cell-PE circuit which may be used with various aspects of the present invention;

FIG. 13 is a block diagram of an AC battery that uses parallel stacked energy blocks with the output of the energy blocks being interfaced to an AC battery terminal output by way of a DC/AC inverter;

FIG. 14 is a schematic diagram of an isolated cell-PC circuit with low voltage and high voltage half-bridge circuits and for use with various aspects of the present invention;

FIG. 15 illustrates an arrangement for an AC battery that uses multiple energy blocks coupled in parallel and where the energy blocks are equipped with DC/AC integrated AC cell-PEs; and

FIG. 16 is a schematic diagram of an example DC/AC inverter-integrated AC cell-PE circuit that is useful for energy blocks to be coupled in parallel with other energy blocks that use AC cell-PE circuits.

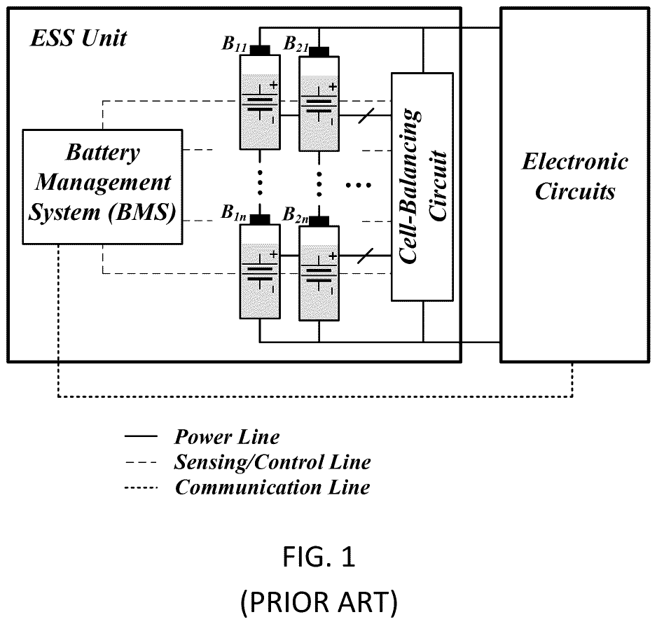

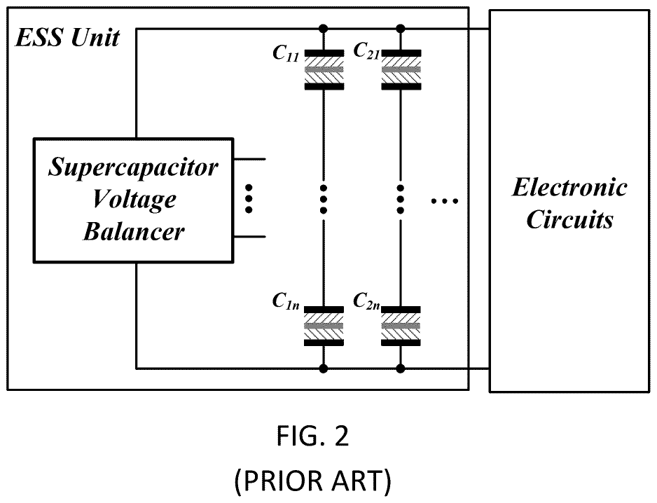

### DETAILED DESCRIPTION

In one aspect of the present invention, there is provided an AC battery architecture that eliminates the need for a combination of a BMS, a voltage balancer, and an inverter. This leads to a very cost-effective energy storage solution for energy systems.

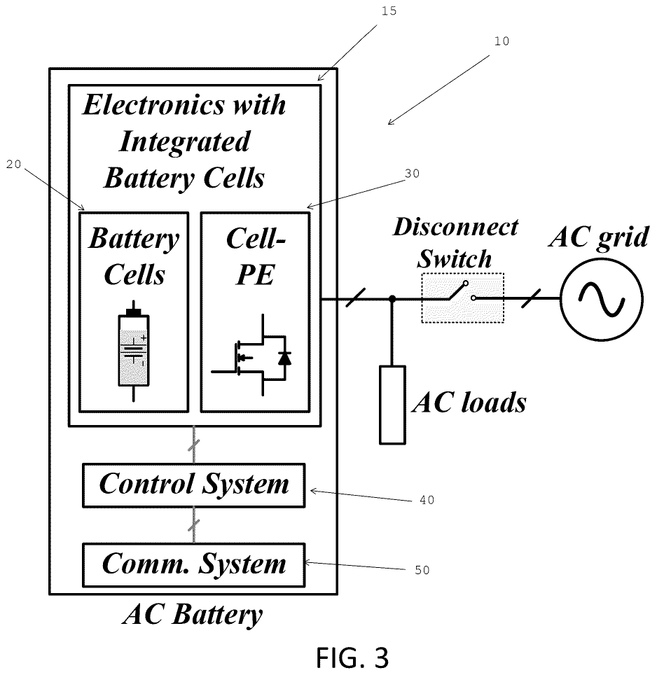

Referring to FIG. 3, the block diagram of an AC battery system according to one aspect of the present invention is illustrated. As can be seen from the figure, the AC battery system 10 includes the following blocks:
an energy block 15 that integrates electronics with energy storage cells, each energy block including the following components:
   energy storage cells 20 that can be primarily battery cells or other energy storage devices such as supercapacitors; and
   a Cell-PE block 30, a block that contains the power electronics components including active switches (e.g., MOSFETs), passive components (e.g., magnetics and capacitors), and integrated control and conditioning circuitry;
a control system block 40 that is responsible for sending various setpoints to the Cell-PE blocks and receive various communication signals from the communication system block; and
a communications block 50 that is responsible for connecting the AC battery system to the outside world by monitoring, importing, and reporting various data to/from the AC battery system.

For clarity, the AC battery system in FIG. 3 can be independent of and self-contained from other AC battery systems as it has its own control system block and communications block. The cell-PE block for such an AC battery system as in FIG. 3 does not have its own control system block nor its own communications block.

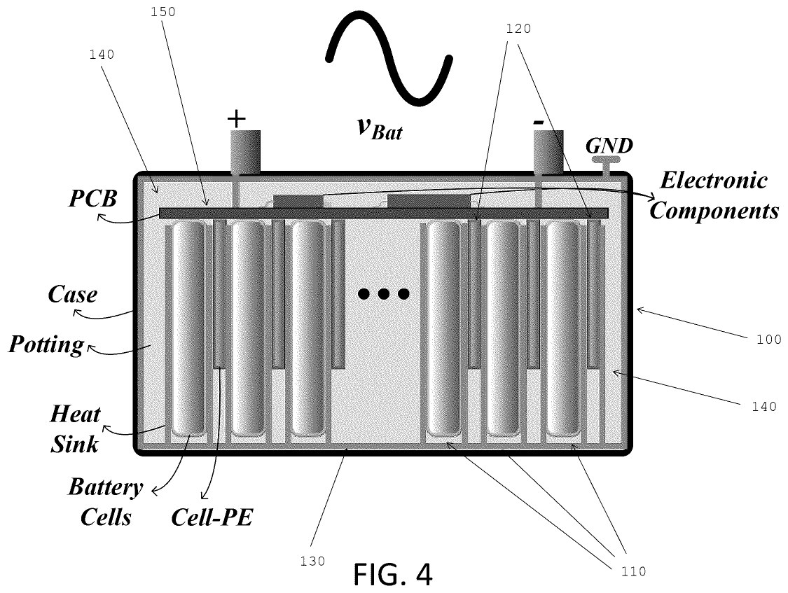

Referring to FIG. 4, illustrated is a block diagram of the AC battery system according to one aspect of the present invention. This arrangement integrates various components of the AC battery system and includes:
a case 100, which includes the mechanical support for the components;
energy storage cells 110, which can be battery cells or other types of energy storage devices (such as supercapacitors);
Cell-PE blocks 120 that are responsible for processing the charge discharge power to-from the battery cells;
a heatsink 130 that is responsible for thermal management of the AC battery system by removing the heat from the energy storage cells and from the Cell-PE blocks;
potting material 140 that provides thermal connectivity between the various components and the heatsink to facilitate the thermal management of the AC battery system; and
printed circuit board (PCB) 150 that provides the required electrical connection between various components.

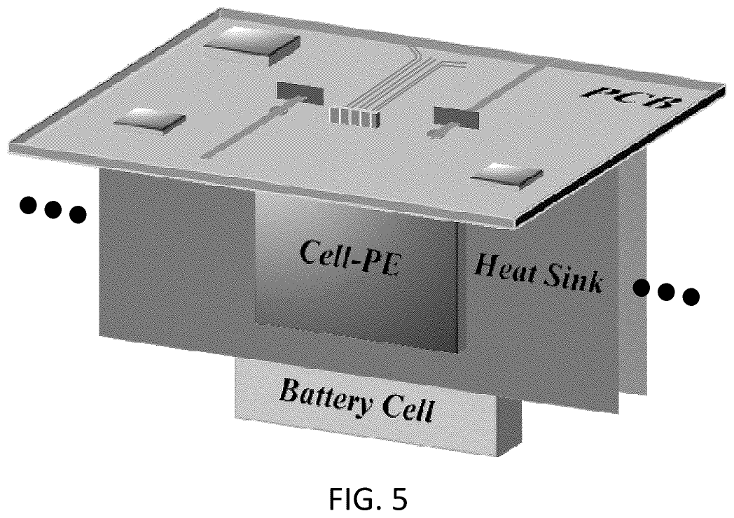

FIG. 5 is a conceptual 3D picture of one arrangement detailing how the battery cell and the Cell-PE may be connected to each other through the PCB. This figure also shows how the heatsink is arranged to conduct the heat away from the battery cell and from the Cell-PE to the outside.

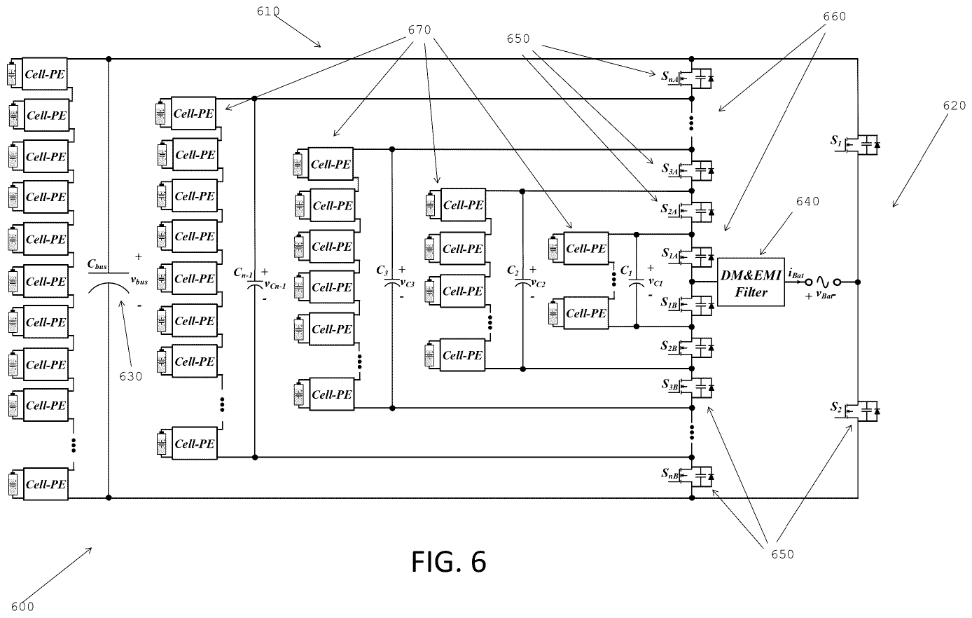

Referring to FIG. 6, illustrated is a schematic diagram of a Multi-Level (ML) DC/AC inverter with integrated battery cells according to another aspect of the present invention. This arrangement is a totem-pole configuration (i.e., it includes one high frequency active leg and one low frequency active leg). The ML DC/AC inverter is responsible for regulating the DC-bus voltage, ν_{bus}, controlling the charge-discharge of the battery cells, and for injecting a high quality, low-ripple frequency AC current to the utility grid. According to FIG. 6, the ML DC/AC inverter 600 includes:
a high frequency active multi-level leg 610, which includes the power semiconductors S_{iA} and S_{iB} along with flying capacitors Cᵢ. These semiconductor switches are controlled such that an appropriate multi-level high frequency bridge-node voltage is generated;
a low frequency active 2-level leg 620, which includes the power semiconductors S₁ and S₂. These semiconductor switches are synchronised with the grid voltage, ν_{g};
battery cells along with the respective capacitors, with the battery cells and their capacitors being responsible for storing energy and releasing that energy when needed;
a DC bus capacitor C_{bus} 630 that is responsible for providing the double-frequency line ripple for the AC battery system.
an EMI filter circuitry 640 as per AC battery requirements.

As can be seen from FIG. 6, the inverter 600 includes a number of circuit element modules (e.g. circuit element modules 650) and a number of flying capacitors (e.g. capacitors C₁, C₂, C₃, Cₙ₋₁), with each circuit element module including a semiconductor, a diode, and a capacitor. For each circuit element module, the diode and capacitor are coupled in parallel with the semiconductor. Most of the circuit element modules are paired with one another. The paired circuit element modules are coupled as a single chain 660 in a series configuration with each pair of circuit element modules being associated with a specific flying capacitor. The associated flying capacitor is coupled to be in parallel with a sub-chain (i.e., coupled in series) of circuit element modules, the sub-chain being bookended by the pair of circuit element modules that the flying capacitor is associated with. Thus, a flying capacitor is coupled between a first coupling point and a second coupling point on the chain and the pair of circuit element modules that is associated with the flying capacitor is coupled in series (to each other or to other modules) between the first and second coupling points. As can be seen, other circuit element modules may also be between those first and second coupling points. The flying capacitors associated with which each pair of circuit element modules are detailed in the table below:

| Flying | First circuit element | Second circuit element |
|---|---|---|
| capacitor | module in the pair | module in the pair |
| C₁ | S_{1A} | S_{1B} |
| C₂ | S_{2A} | S_{2B} |
| C₃ | S_{3A} | S_{3B} |
| Cₙ₋₁ | S_{(n-1)A} | S_{(n-1)B} |
| C_{bus} | S_{nA} | S_{nB} |

It can also be seen that the EMI filter circuitry 640 is coupled, at one end, to a coupling point that is exactly midway in the single chain 660. At the other end, circuitry 640 is coupled to the output of the system 600.

It should also be quite plain from FIG. 6 that each flying capacitor Cₙ₋₁ is also coupled in parallel with an associated string of energy blocks 670 that are coupled to one another in series. Each energy block consists of an energy storage cell coupled in parallel with a Cell-PE block. It should be clear that there may be any number of energy blocks in the string of energy blocks that is coupled in parallel to a flying capacitor. And, of course, is also a string of energy blocks coupled in parallel to the DC bus capacitor 630. For clarity, this DC bus capacitor 630 is coupled in parallel with the whole chain 660 of circuit element modules.

Again referring to FIG. 6, in parallel with the chain 660 of circuit element modules are two output modules S₁, S₂ coupled in series with each other on the low frequency active 2-level leg 620. Midway along the chain 660 of modules is the EMI filter circuitry 640. The output of the power circuit is taken between the filter circuitry 640 and a coupling point that is between the output modules S₁, S₂. This output is the output to the AC grid as shown in FIG. 3.

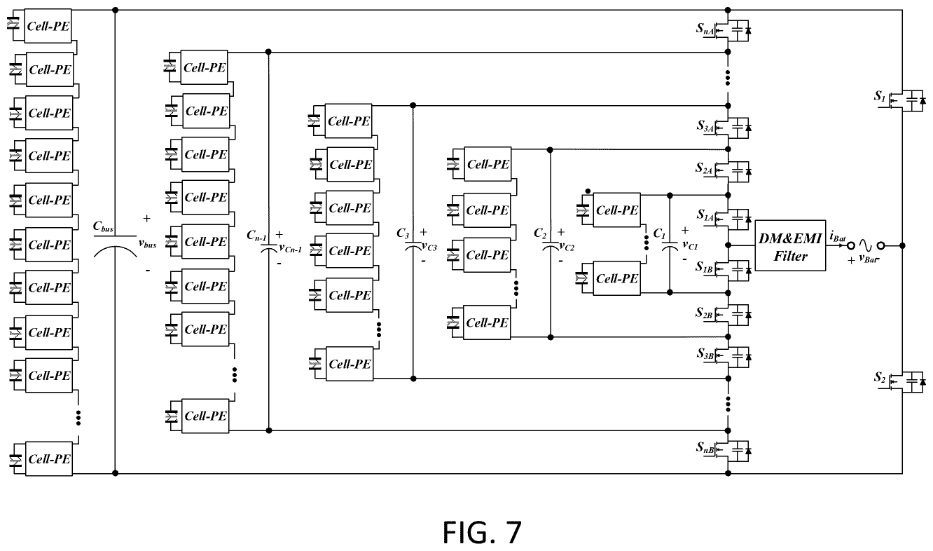

FIG. 7 shows an architecture of an inverter similar to that shown in FIG. 6 but where the energy storage cell in each energy block is a supercapacitor cell.

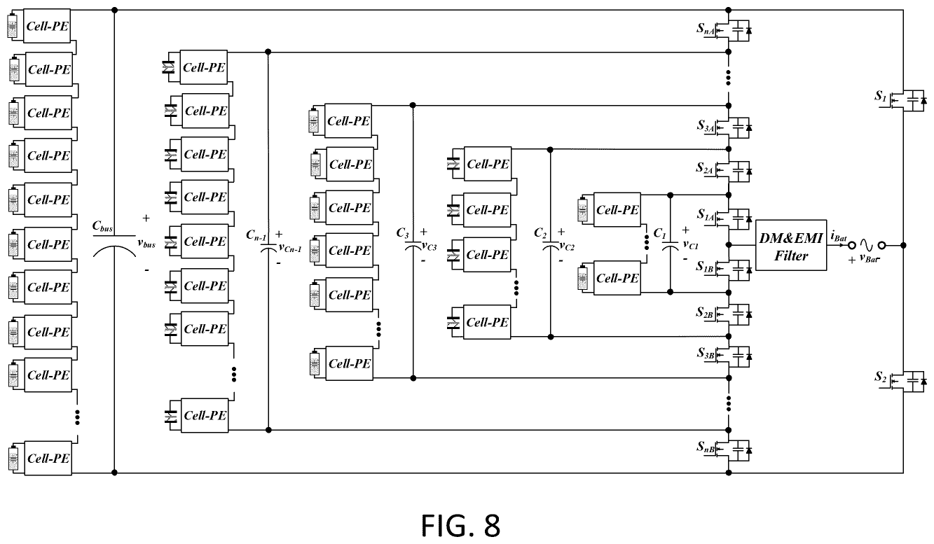

FIG. 8 shows an architecture of an inverter similar to that shown in FIG. 6 but where the energy storage cell in each energy block is a hybrid supercapacitor and battery cell.

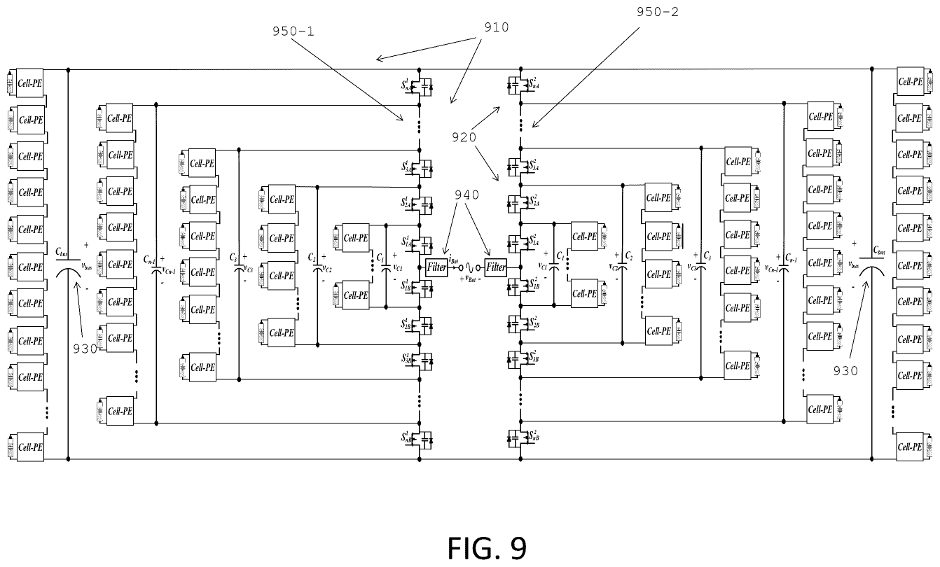

Referring to FIG. 9, provided is a schematic diagram of a Multi-Level (ML) DC/AC Inverter with integrated battery cells according to another aspect of the present invention. This arrangement is of a full-bridge configuration (i.e., it includes two high frequency active legs). The ML DC/AC inverter is responsible for regulating the DC-bus voltage, ν_{bus}, controlling the charge-discharge of the battery cells, and for injecting a high quality, low-ripple frequency AC current to the utility grid. According to FIG. 9, the ML DC/AC inverter 900 includes:
two high frequency active multi-level legs 910, 920, which include the power semiconductors S^{x}_{iA} and S^{x}_{iB} and the power semiconductors S^{y}_{iA} and S^{y}_{iB}. These semiconductor switches are controlled such that an appropriate multi-level high frequency bridge-node voltage is generated;
battery cells, along with their respective capacitors, that are responsible for storing energy and releasing energy when needed;
a DC bus capacitor 930 (one per leg) that is responsible for providing the double-frequency line ripple for the AC battery system;
EMI filter circuitry 940 as per AC battery requirements (one per leg).

Referring to FIG. 9, it can be seen that, instead of a single chain of circuit element modules, there are two chains 950-1, 950-2. Each chain of circuit element modules has a single chain of series coupled circuit element modules, with each circuit element module being paired with another circuit element module. For each pair of paired circuit element modules, there is associated a specific flying capacitor and each specific flying capacitor is coupled in parallel with a sub-chain (i.e., coupled in series) of circuit element modules, the sub-chain being bookended by the pair of circuit element modules that the flying capacitor is associated with. Thus, a flying capacitor is coupled between a first coupling point and a second coupling point on the chain and the pair of circuit element modules that is associated with the flying capacitor is coupled in series (to each other or to other modules) between the first and second coupling points. As can be seen, other circuit element modules may also be between those first and second coupling points. The flying capacitors associated with which each pair of circuit element modules on the first chain of modules 950-1 (the chain of modules on the left) are detailed in the table below:

| Flying | First circuit element | Second circuit element |
|---|---|---|
| Capacitor | module in the pair | module in the pair |
| C₁ | S¹_{1A} | S¹_{1B} |
| C₂ | S¹_{2A} | S¹_{2B} |
| C₃ | S¹_{3A} | S¹_{3B} |
| Cₙ₋₁ | S¹_{(n-1)A} | S¹_{(n-1)B} |
| C_{bus} | S¹_{nA} | S¹_{nB} |

For the second chain of modules 950-2 (the chain of modules on the right), the flying capacitors associated with which each pair of circuit element modules are detailed in the table below:

| Flying | First circuit element | Second circuit element |
|---|---|---|
| Capacitor | module in the pair | module in the pair |
| C₁ | S²_{1A} | S²_{1B} |
| C₂ | S²_{2A} | S²_{2B} |
| C₃ | S²_{3A} | S²_{3B} |
| Cₙ₋₁ | S²_{(n-1)A} | S²_{(n-1)B} |
| C_{bus} | S²_{nA} | S²_{nB} |

As can also be seen from FIG. 9, each of the two chains 950-1, 950-2 has an EMI filter circuitry block 940 coupled to a coupling point that is in the middle of each chain. Each of these filter circuitry blocks 940 is coupled between the system output and the coupling point midway in the associated chain of modules. Of course, as can be seen, each of the two chains 950-1, 950-2 is coupled in parallel to the other chain.

Also from FIG. 9, it can be seen that each flying capacitor Cₙ (including C_{bus}) is also coupled in parallel with an associated string of energy blocks 960 that are coupled to one another in series. Much like in FIG. 8, each energy block consists of an energy storage cell coupled in parallel with a Cell-PE block. It should be clear that there may be any number of energy blocks in the string of energy blocks that is coupled in parallel to a flying capacitor. And, of course, is also a string of energy blocks coupled in parallel to the DC bus capacitor 930. For clarity, each of the two DC bus capacitors 930 is coupled in parallel with each of the whole chains 950-1, 950-2 of circuit element modules. For FIG. 9, each energy block is equipped with a battery as its energy storage cell.

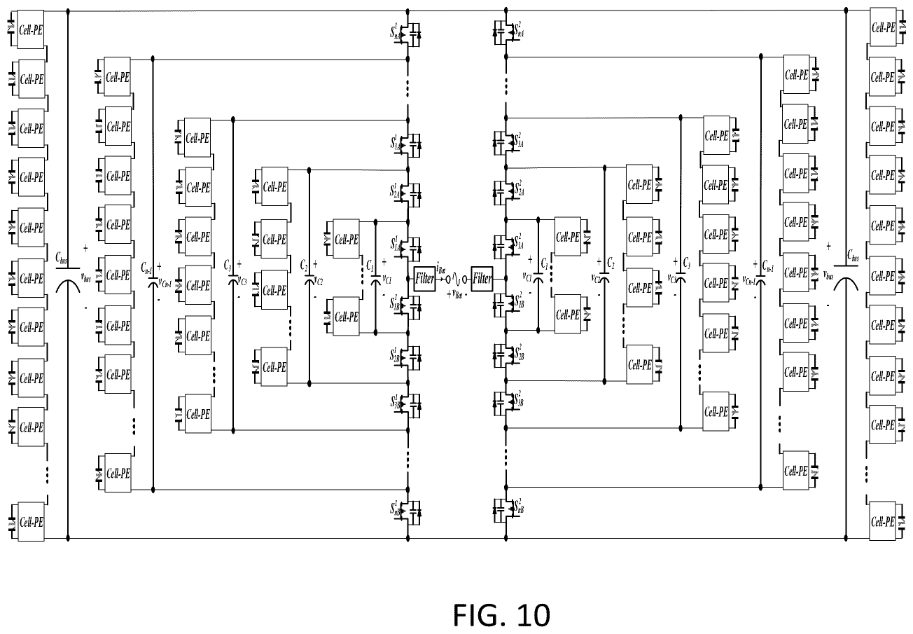

FIG. 10 shows an architecture of an inverter similar to that shown in FIG. 9 but where the energy storage cell in each energy block is a supercapacitor cell.

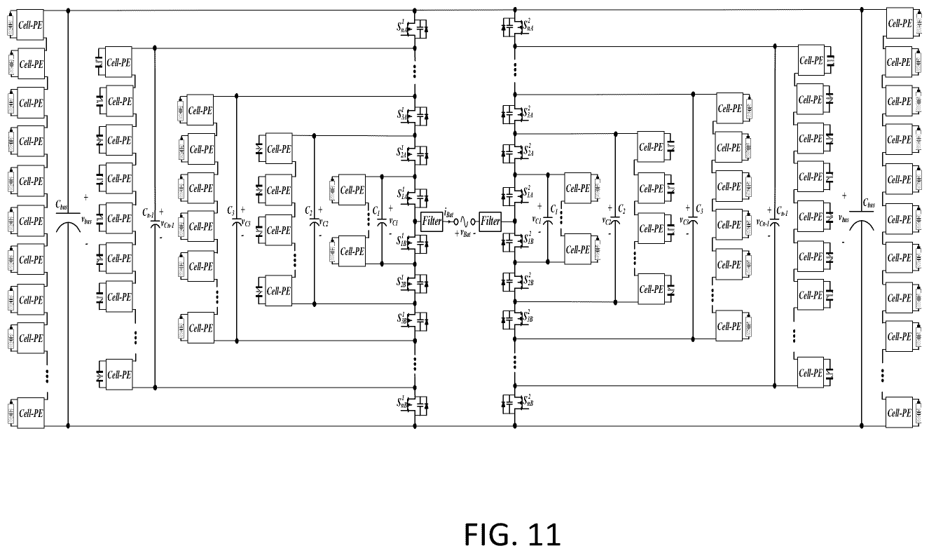

FIG. 11 shows an architecture of an inverter similar to that shown in FIG. 9 but where the energy storage cell in each energy block is a hybrid supercapacitor and battery cell.

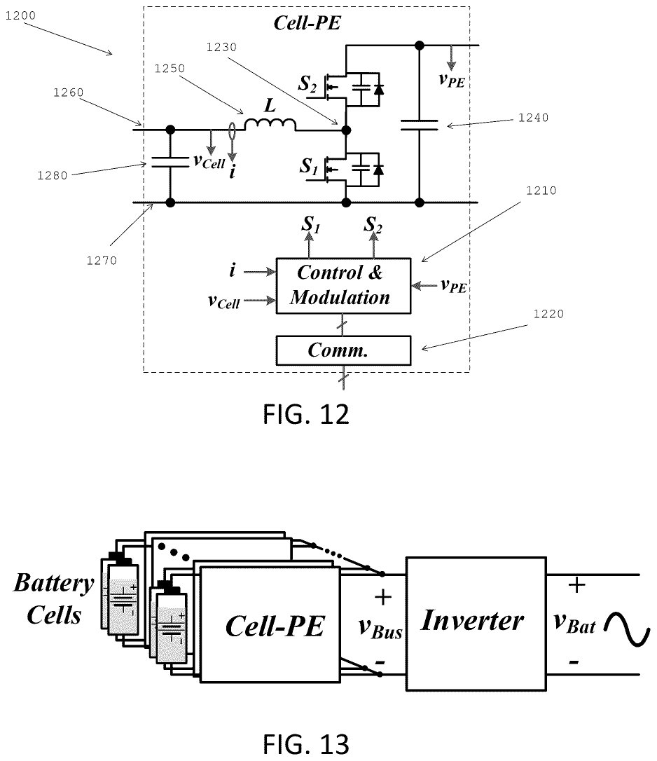

FIG. 12 shows an example of a non-isolated cell-PE circuit. This circuit can provide bi-directional operation in boost (discharging) and buck (charging) modes. According to this figure, the non-isolated cell-PEs circuit 1200 includes:
power semiconductors S₁ and S₂ with switching logic to provide either buck or boost mode of operation;
a control and modulation digital block 1210 to generate switch gating logic for the S₁ and S₂ semiconductors. Tight control of critical circuit variables such as cell voltage, cell current, and PE voltage is ensured via this control block 1210;
a communication port/entity/block 1220 based on a suitable protocol to accept digital commands from a centralized processor or external communication hub. Commands received by the block 1220 can include the charging/discharging set-point of battery cells, the provision of relevant data for monitoring critical cell parameters as well as other commands that cover additional converter operation purposes.

As can be seen from FIG. 12, each of the semiconductors S₁, S₂ is in a semiconductor module. In this case, the semiconductor module consists of the semiconductor, a capacitor, and a diode. The capacitor is coupled in parallel with the diode and is coupled in between the source and drain leads of the semiconductor. The modules are coupled in series with a coupling point 1230 between the modules. An output capacitor 1240 is coupled in parallel with the series-coupled semiconductor modules. An inductor 1250 is coupled between the coupling point 1230 and one input 1260 to the circuit 1200. The other input 1270 to the circuit 1200 serves as a coupling point to one end of the series-coupled semiconductor modules and to the output capacitor 1240. As well, an input capacitor 1280 is coupled between the input 1260 and input 1270. One or more energy cells is coupled between input 1260 and input 1270. For clarity, the energy cell, combined with the cell-PE circuit 1200 forms an energy block. As can be seen from FIG. 12, such an energy block (which includes the cell-PE circuit with its own control and modulation block and communications block and the energy cell) can be independent of other energy blocks. Such an energy block can thus be stacked and each of the stacked energy blocks can be independently controlled of the other stacked energy blocks.

FIG. 13 shows an arrangement that uses multiple cell-PEs stacked in parallel to feed a common DC-link port. As can be seen, the arrangement has multiple energy blocks coupled in parallel to a DC-link port. For this arrangement, all the energy blocks have a battery as an energy storage cell. The common DC bus port can be connected to a DC/AC inverter to inject high-quality AC current by way of the AC battery system terminal.

For greater clarity, the configuration in FIG. 13 uses energy blocks that use the cell-PE circuit in FIG. 12. Accordingly, each energy block in FIG. 12 can be, if desired, independently controlled of other energy blocks as each energy block is equipped with its own cell-PE circuit and this cell-PE circuit has its own control and modulation block and its own communications block.

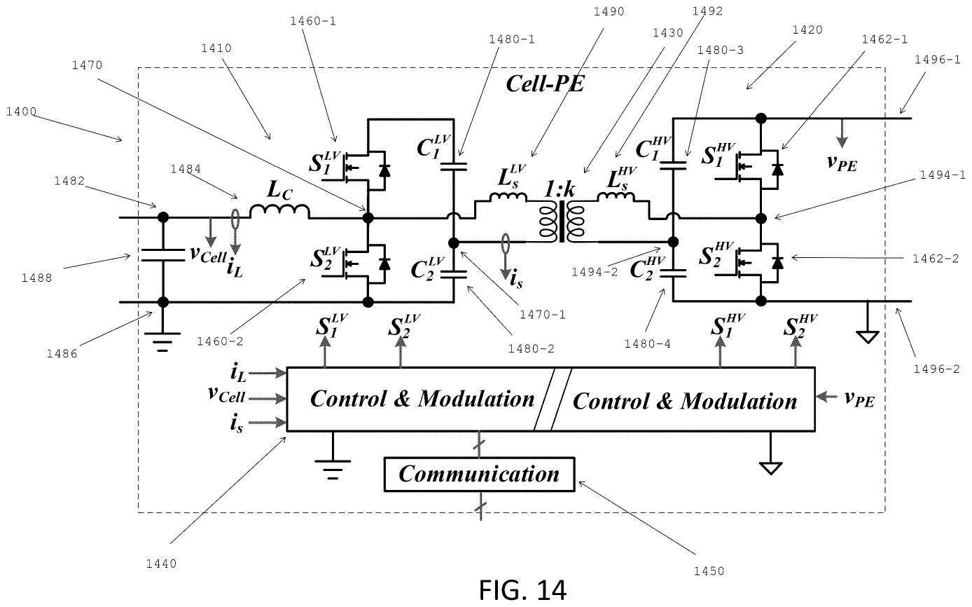

FIG. 14 shows an example of an isolated cell-PE circuit 1400 suitable for structures that may need parallel cell-PE stacking. This circuit 1400 can provide isolated bi-directional DC/DC conversion operation in boost (discharging) and buck (charging) modes. According to FIG. 14, the isolated cell-PEs circuit 1400 includes:
a low-voltage half-bridge circuit 1410 with split-capacitor

$$( {C}_{1}^{LV} , {C}_{2}^{LV} )$$

arrangement, comprising power semiconductors

$${S}_{1}^{LV} and {S}_{2}^{LV} .$$

A series inductor,

$${L}_{s}^{L V}$$

(discrete, integrated, or a combination of both) is connected to achieve soft-switching operation of the low-voltage power semiconductors in either direction of power flow;
a high-voltage half-bridge circuit 1420 with split-capacitor

$$( {C}_{1}^{HV} , {C}_{2}^{HV} )$$

arrangement, comprising power semiconductors

$${S}_{1}^{HV} and {S}_{2}^{HV} .$$

A series inductor,

$${L}_{s}^{H V}$$

(discrete, integrated, or a combination of both) is connected to achieve soft-switching operation of the high-voltage power semiconductors in either direction of power flow;
an isolation transformer 1430, with necessary turns-ratio to provide required voltage gain.
a control and modulation digital block 1440 to generate switch gating logic for

$${S}_{1}^{LV} , {S}_{2}^{LV} , {S}_{1}^{HV} , and {S}_{2}^{HV} .$$

Tight control of critical circuit variables such as cell voltage, cell current, and PE voltage is ensured via this control block. Switching logic and/or mode of operation for bi-directional DC/DC stage can be modified based on primary series current, i_{S};
a communication port/entity 1450 based on a suitable protocol to accept digital commands from a centralized processor or external communication hub. Commands can include: the charging/discharging set-point of battery cells, the provision of relevant data for monitoring critical cell parameters, as well other commands that relate to additional converter operation purposes.

As can be seen from FIG. 14, the four semiconductors are each part of a semiconductor module. For the circuit in FIG. 14, however, each semiconductor module simply consists of the semiconductor and a diode coupled between the source and drain leads of the semiconductor. As well, it should be clear that the circuit 1400 has a low voltage half bridge circuit 1410 and a high voltage half bridge circuit.

The low voltage half-bridge circuit 1410 has two semiconductor modules 1460-1, 1460-2 coupled in series with a coupling point 1470 in between the semiconductor modules. Coupled in parallel with the series-coupled semiconductor modules are a series coupled capacitors 1480-1, 1480-2. These capacitors

$$( {C}_{1}^{LV} , {C}_{2}^{LV} )$$

provide the split capacitor arrangement noted above. Between the coupling point 1470 and an input point 1482 is an inductor L_{C} 1484. Between input point 1482 and input point 1486 is coupled a capacitor 1488. For clarity, the input points 1482, 1486 provide the coupling points for one or more energy storage cells. The energy storage cell(s), combined with the cell-PE circuit in FIG. 14, forms an independent energy block with its own control and modulation circuitry and its own communications circuitry. One or more of these energy blocks can be used to form an AC battery system according to another aspect of the present invention.

A low voltage inductor 1490 is coupled between coupling point 1470 and one input to a first side of the transformer 1430. The other input to this first side of the transformer 1430 is coupled to a coupling point 1470-1 that is between the series coupled output capacitors 1480-1, 1480-2.

For the high voltage half-bridge circuit 1420, the arrangement mirrors the low voltage half-bridge circuit 1410. The second side of the transformer 1430 has one output coupled to a high voltage inductor 1492. This high voltage inductor 1492 is coupled, at its other end, to a coupling point 1494-1 that is between a series connected pair of high voltage semiconductor modules 1462-1, 1462-2. Coupled in parallel to this pair of semiconductor modules is a pair of series coupled capacitors 1480-3, 1480-4 in, again, a split capacitor arrangement. A coupling point 1494-2 is between these capacitors 1480-3, 1480-4. This coupling point 1492-2 is coupled to the other output of the second side of transformer 1430. The series-coupled pair of capacitors 1480-3, 1480-4 and the series-coupled pair of high voltage semiconductor modules 1462-1, 1462-2 are coupled in parallel to one another and are coupled between a first output lead 1496-1 and a second output lead 1496-2.

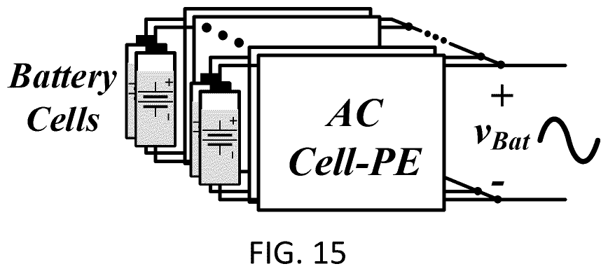

FIG. 15 shows an arrangement with multiple energy blocks that are equipped with DC/AC inverter-integrated AC cell-PEs. For this arrangement, the energy blocks are stacked in parallel to provide the required high-quality AC current and AC voltage at the AC battery system output terminals. Again, for this arrangement, all the energy blocks have a battery as an energy storage cell. Each energy block in FIG. 15 may be equipped with the DC/AC inverter-integrated AC cell-PE as shown in FIG. 14. As well, each energy block in FIG. 15 may be independently controlled and operated as necessary as each energy block has its own control and modulation block and its own communications block that is part of its inverter-integrated AC cell-PE circuitry.

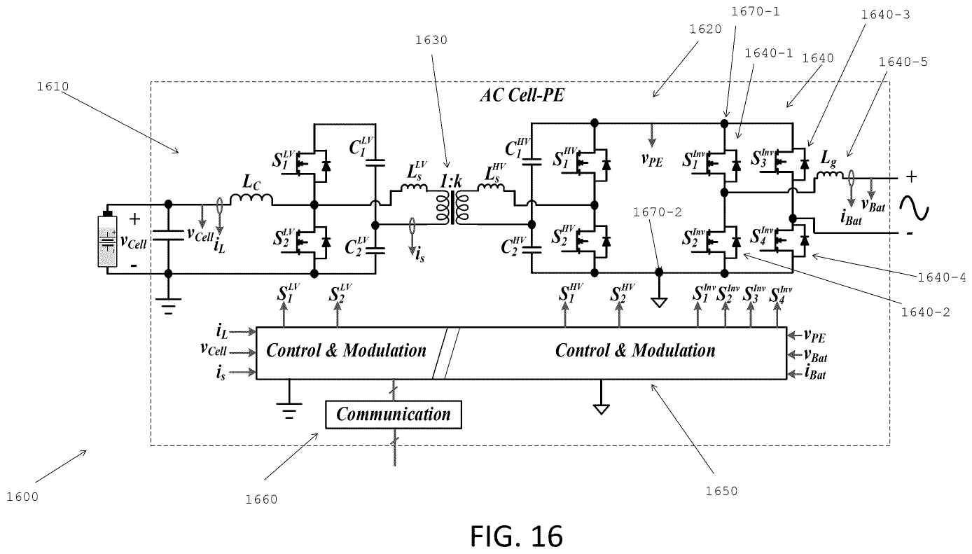

FIG. 16 illustrates an example of a DC/AC inverter-integrated AC cell-PE circuit suitable for structures that may need parallel stacking of energy blocks that use AC cell-PE circuits. This circuit can provide isolated bi-directional DC/DC conversion operation in boost (discharging) and buck (charging) modes along with a DC/AC inverter. According to FIG. 16, the isolated AC cell-PEs circuit 1600 includes:
a low-voltage half-bridge circuit 1610 with a split-capacitor arrangement (using capacitors

$${C}_{1}^{LV} , {C}_{2}^{LV} ) .$$

This half-bridge circuit uses power semiconductors

$${S}_{1}^{LV} and {S}_{2}^{LV} .$$

A series inductor,

$${L}_{s}^{L V}$$

(an inductor that is discrete, integrated, or a combination of both) is connected to achieve soft-switching operation of the low-voltage power semiconductors in either direction of power flow;
a high-voltage half-bridge circuit 1620 with split-capacitor arrangement (using capacitors

$${C}_{1}^{HV} , {C}_{2}^{HV} ) .$$

This high voltage circuit uses power semiconductors

$${S}_{1}^{HV} , and {S}_{2}^{HV} .$$

A series inductor,

$${L}_{s}^{HV}$$

(an inductor that is discrete, integrated, or a combination of both) is connected to achieve soft-switching operation of the high-voltage power semiconductors in either direction of power flow;
an isolation transformer 1630, with the necessary turns-ratio to provide the required voltage gain;
a full-bridge DC/AC inverter circuit 1640 that includes power semiconductors 1640-1, 1640-2, 1640-3, 1640-4

$$( {S}_{1}^{Inv} , {S}_{2}^{Inv} , {S}_{3}^{Inv} , and {S}_{4}^{Inv} )$$

along with AC grid filter 1640-5, L_{g}, as per AC battery requirements;
a control and modulation digital block 1650 to generate switch gating logic for semiconductors

$${S}_{1}^{LV} , {S}_{2}^{LV} , {S}_{1}^{HV} , and {S}_{2}^{HV} .$$

Tight control of critical circuit variables such as cell voltage, cell current, and PE voltage is ensured via this control block. Switching logic and/or mode of operation can be modified based on a primary series current, i_{S}. Switch gating logic for

$${S}_{1}^{Inv} , {S}_{2}^{Inv} , {S}_{3}^{Inv} , and {S}_{4}^{Inv}$$

is provided by this block;
a communication port/entity 1660 based on a suitable protocol to accept digital commands from a centralized processor or external communication hub. Commands can include: the charging/discharging set-point of battery cells, the provision of relevant data for monitoring critical cell parameters, as well other commands that relate to additional converter operation purposes.

Referring to FIG. 16, it should be clear that the circuit in FIG. 16 is almost identical to the circuit in FIG. 14. The FIG. 16 circuit differs from the FIG. 14 circuit in that the FIG. 16 circuit includes an inverter subcircuit that is coupled to the high voltage half-bridge circuit. As can be seen, between the connection point 1670-1, 1670-2 is coupled the inverter subcircuit 1640. This subcircuit 1640 has a pair of semiconductor modules 1640-1, 1640-2 (coupled in series to each other) and this pair of series-coupled semiconductor modules is coupled in parallel to another pair of series-coupled semiconductor modules 1640-3, 1640-4. One end of inductor 1640-5 L_{g} is coupled to a connection point between modules 1640-1, 1640-2 while the other end of inductor 1640-5 is one output lead. The other output lead is coupled to a connection point that is between the modules 1640-3, 1640-4.

For greater clarity, while the inverter sub-circuitry in FIG. 16 is a full-bridge circuit, other structures may be used. However, it has been found that a full-bridge circuit, as illustrated, provided optimal results.

A person understanding this invention may now conceive of alternative structures and embodiments or variations of the above all of which are intended to fall within the scope of the invention as defined in the claims that follow.

We claim:

1. A power cell system for providing power to grids or loads requiring AC power, the system comprising:
at least one power block, each power block comprising:
at least one energy storage cell for storing energy;
a circuitry sub-block containing circuitry for power flow to and from said at least one energy cell and for energy conditioning for said at least one energy cell;
a control sub-system for controlling said at least one power block and for setting parameters for said circuitry sub-block in said at least one power block;
wherein said power cell system outputs AC power.

2. The power cell system according to claim 1 further comprising a communications block for receiving and transmitting data to and from said power cell system, said data being received and sent from said control sub-system.

3. The power cell system according to claim 1 further comprising at least one heat sink.

4. The power cell system according to claim 1 wherein said power cell system comprises:
a plurality of pairs of circuit element modules, each of said circuit element modules comprising a semiconductor;
a plurality of said flying capacitors, each flying capacitor being associated with a specific pair of circuit element modules;
a pair of output circuit element modules coupled to each other in series;
an EMI filter circuitry block;
wherein
each of said plurality of circuit element modules is coupled in series to other circuit element modules to form a chain of circuit element modules;
each flying capacitor is coupled between a first coupling point and a second coupling point in said chain of circuit element modules and each flying capacitor and each pair of circuit element modules are arranged in said chain such that, for each specific flying capacitor, a specific pair of circuit element modules associated with said specific flying capacitor is coupled in said chain between a specific first coupling point and a specific second coupling point between which said specific flying capacitor is coupled;
said output circuit element modules in series is coupled in parallel with said chain;
said EMI filter circuitry block is coupled between an output of said power block and a coupling point that is midway in said chain;
said output is coupled to a point midway between said output circuit element modules;
each flying capacitor is coupled in parallel with a string of series coupled energy blocks;
switching pulses produced by said control sub-system controls said semiconductors in said circuit element modules.

5. The power cell system according to claim 4 wherein each energy storage cell in each energy block is one of: a battery, a supercapacitor, and a hybrid of a battery and a supercapacitor.

6. The power cell system according to claim 1 wherein said power cell system comprises:
a plurality of pairs of circuit element modules, each of said circuit element modules comprising a semiconductor, said plurality of pairs of circuit element modules being arranged in two chains of circuit element modules;
a plurality of said flying capacitors, each flying capacitor being associated with a specific pair of circuit element modules;
a first output filter circuitry block and a second output filter circuitry block;
wherein
each of said plurality of circuit element modules is coupled in series to other circuit element modules to thereby form said two chains of circuit element modules, a first chain of circuit element modules being in parallel with a second chain of circuit element modules;
each flying capacitor being coupled between a first coupling point and a second coupling point in said chain of circuit element modules and each flying capacitor and each pair of circuit element modules are arranged in one of said two chains such that, for each specific flying capacitor, a specific pair of circuit element modules associated with said specific flying capacitor is coupled in said one of two chains between a specific first coupling point and a specific second coupling point between which said specific flying capacitor is coupled;
said first output filter circuitry block is coupled between an output and a first coupling point midway in said first chain of circuit element modules;
said second output filter circuitry block is coupled between said output and a second coupling point midway in said second chain of circuit element modules;
each flying capacitor is coupled in parallel with a string of series coupled energy blocks;
switching pulses produced by said control sub-system controls said semiconductors in said circuit element modules.

7. The power cell system according to claim 6 wherein each energy storage cell in each energy block is one of: a battery, a supercapacitor, and a hybrid of a battery and a supercapacitor.

8. The power cell system according to claim 1 wherein for at least one power block, said circuitry sub-block comprises:
a pair of circuit element modules, each of said circuit element modules comprising a semiconductor, said pair of circuit element modules being coupled in series to result in a series-coupled pair of circuit element modules;
an output capacitor coupled in parallel with said series-coupled pair of circuit element modules;
an inductor coupled between a first input lead and a coupling point, said coupling point being between said pair of circuit element modules;
an input capacitor coupled between said first input lead and a second input lead;
a control and modulation sub-block for generating gating logic for semiconductors in said circuit element modules;
wherein said second input lead is coupled to said series-coupled pair of circuit element modules and to said output capacitor;
wherein, in each of said at least one power block, one or more energy storage cells are coupled between said first input lead and said second input lead.

9. The power cell system according to claim 8 wherein, for said at least one power block, said circuitry sub-block incorporates said control sub-system and further comprises a communications sub-block.

10. The power cell system according to claim 1 wherein for at least one power block, said a circuitry sub-block comprises:
a low-voltage half-bridge circuit;
a high voltage half-bridge circuit;
an isolation transformer coupled between said low-voltage half-bridge circuit and said high voltage half-bridge circuit;
wherein said control subsystem generates gating logic for semiconductors in said low-voltage half-bridge circuit and in said high-voltage half-bridge circuit.

11. The power cell system according to claim 10 wherein, for said at least one power block, said circuitry sub-block incorporates said control sub-system and further comprises a communications sub-block.

12. The power cell system according to claim 10 wherein said low-voltage half-bridge circuit comprises:
a pair of low voltage circuit element modules, each of said low voltage circuit element modules comprising a semiconductor, said pair of low voltage circuit element modules being coupled in series to result in a series-coupled pair of low voltage circuit element modules;
a pair of output capacitors coupled in series with each other to result in a series-coupled pair of output capacitors, said series coupled pair of output capacitors being coupled in parallel with said series-coupled pair of low voltage circuit element modules;
an input inductor coupled between a first input lead and a first coupling point, said coupling point being between said pair of circuit element modules;
an input capacitor coupled between said first input lead and a second input lead;
an output inductor coupled between said first coupling point and a first input to said isolation transformer;
wherein a second input to said isolation transformer is coupled to a second coupling point, said second coupling point being between said pair of output capacitors.

13. The power cell system according to claim 10 wherein said high-voltage half-bridge circuit comprises:
a pair of high voltage circuit element modules, each of said high voltage circuit element modules comprising a semiconductor, said pair of high voltage circuit element modules being coupled in series to result in a series-coupled pair of high voltage circuit element modules;
a pair of input capacitors coupled in series with each other to result in a series-coupled pair of input capacitors, said series-coupled pair of input capacitors being coupled in parallel with said series-coupled pair of high voltage circuit element modules;
an input high voltage inductor coupled between a first coupling point and a first output of said isolation transformer, said first coupling point being between said pair of high voltage circuit element modules;
wherein a second output from said isolation transformer is coupled to a second coupling point, said second coupling point being between said pair of input capacitors;
wherein said pair of high voltage circuit element modules and said pair of input capacitors are coupled between a first output lead and a second output lead.

14. The power cell system according to claim 1 wherein for at least one power block, said circuitry sub-block comprises:
a low-voltage half-bridge circuit;
a high voltage half-bridge circuit;
an isolation transformer coupled between said low-voltage half-bridge circuit and said high voltage half-bridge circuit;
a full-bridge inverter circuit coupled to said high voltage half-bridge circuit;
wherein said control sub-system generates gating logic for:
semiconductors in said low-voltage half-bridge circuit;
semiconductors in said high-voltage half-bridge circuit; and
semiconductors in said full-bridge inverter circuit.

15. The power cell system according to claim 14 wherein, for said at least one power block, said circuitry sub-block incorporates said control sub-system and said a communications sub-block.

16. The power cell system according to claim 14 wherein said low-voltage half-bridge circuit comprises:
a pair of low voltage circuit element modules, each of said low voltage circuit element modules comprising a semiconductor, said pair of low voltage circuit element modules being coupled in series to result in a series-coupled pair of low voltage circuit element modules;
a pair of output capacitors coupled in series with each other to result in a series-coupled pair of output capacitors, said series coupled pair of output capacitors being coupled in parallel with said series-coupled pair of low voltage circuit element modules;
an input inductor coupled between a first input lead and a first coupling point, said coupling point being between said pair of circuit element modules;
an input capacitor coupled between said first input lead and a second input lead;
an output inductor coupled between said first coupling point and a first input to said isolation transformer;
wherein a second input to said isolation transformer is coupled to a second coupling point, said second coupling point being between said pair of output capacitors.

17. The power cell system according to claim 14 wherein said high-voltage half-bridge circuit comprises:
a pair of high voltage circuit element modules, each of said high voltage circuit element modules comprising a semiconductor, said pair of high voltage circuit element modules being coupled in series to result in a series-coupled pair of high voltage circuit element modules;
a pair of input capacitors coupled in series with each other to result in a series-coupled pair of input capacitors, said series-coupled pair of input capacitors being coupled in parallel with said series-coupled pair of high voltage circuit element modules;
an input high voltage inductor coupled between a first coupling point and a first output of said isolation transformer, said first coupling point being between said pair of high voltage circuit element modules;
wherein a second output from said isolation transformer is coupled to a second coupling point, said second coupling point being between said pair of input capacitors;
wherein said pair of high voltage circuit element modules and said pair of input capacitors are coupled between a first output lead and a second output lead;
wherein said first output lead and said second output lead are coupled to said full-bridge inverter circuit.

18. The power cell system according to claim 14 wherein said full-bridge inverter circuit comprises:
a first pair and a second pair of inverter circuit element modules, each of said inverter circuit element modules comprising a semiconductor, said first pair of inverter circuit element modules being coupled in series to result in a first series-coupled pair of inverter circuit element modules and said second pair of inverter circuit element modules being coupled in series to result in a second series-coupled pair of inverter circuit element modules, said first series-coupled pair of inverter circuit element modules and second series-coupled pair of inverter circuit element modules being coupled in parallel to each other;
an AC grid filter coupled between a first output lead and a first coupling point between said first pair of inverter circuit element modules;
wherein a second output lead is coupled to a second coupling point between said second pair of inverter circuit element modules.

19. The power cell system according to claim 1 wherein said power cell system comprises at least two power blocks that are coupled in parallel.
